(19) United States
(12) Patent Application Publication
(10) Pub. No.: US 2026/0058942 A1
(43) Pub. Date: Feb. 26, 2026

(54) METHODS AND SYSTEMS FOR PROVIDING SERVICE RESPONSES FOR FACILITY EMERGENCIES

(71) Applicant: Vanessa Osbourne, Wake Forest, NC (US)

(72) Inventor: Vanessa Osbourne, Wake Forest, NC (US)

(21) Appl. No.: 18/811,470

(22) Filed: Aug. 21, 2024

(51) Int. Cl. H04L 9/40; G06Q 50/26

(52) U.S. Cl. CPC H04L 63/083; G06Q 50/265

(57) ABSTRACT

The present invention relates to systems and methods for providing service responses for facility emergencies. The method performed by an application server includes rendering at least a plurality of service categories and one or more service features associated with an application to a plurality of users of the application. The plurality of service categories and the one or more service features associated with the application are rendered to the plurality of users upon successful registration of the plurality of users to the application. Further, the method includes receiving a selection input provided by the plurality of users in the application to access one of a service category of the plurality of service categories and a service feature of the one or more service features. The method further includes rendering a service response corresponding to the selected service category and the selected service feature to the plurality of users.

### TECHNICAL FIELD

The present invention relates to electronic systems and methods for providing safety assistance, and more particularly relates to methods and systems for providing service responses for facility emergencies occurring at a facility/workplace.

### BACKGROUND

Safety and risk management in the workplace during emergency situations involve strategies and practices designed to protect employees and minimize the potential for accidents and injuries. Safety and risk management in critical situations demands skills such as effective communication and situational awareness, as well as strong decision-making abilities, particularly under conditions of high uncertainty or stress. Emergency situations are marked by a high level of unpredictability, limited control over the involved parameters, and often very less time to assess the situation and determine necessary actions. Effectively managing and acting under these uncertain conditions becomes crucial. To integrate these competencies, it is essential to use advanced scenarios, engage in iterative and regular training to gain sufficient experience and conduct thorough debriefings.

Effective safety and risk management creates a safer work environment thereby reducing the likelihood of accidents, and contribute to overall productivity and well-being of the employee. However, in the recent times safety and risk management in the workplace is challenging as it can encompass various aspects from regulatory compliance, operational processes administration, and fatigue management to behavioural cultivation of the operators or personnel. The conventional safety approach deployed in the workplace may rely on paper documents which may cause clerical overload, procedural compliance mistakes, lack of real-time monitoring and capability of enforcing safety laws. Additionally, an individual in the workplace may not have adequate access to concise and clear data indicating the safety instructions and equipment, and lack of ability to assess the risk.

Therefore, there is a need for systems and methods for providing service responses for facility emergencies occurring at a facility/workplace that overcome the aforementioned deficiencies along with providing other advantages.

### SUMMARY

Various embodiments of the present disclosure disclose methods and systems for providing service responses for facility emergencies occurring at a facility/workplace.

In an embodiment, a computer-implemented method is disclosed. The computer-implemented method performed by an application server includes rendering at least a plurality of service categories and one or more service features associated with an application to a plurality of users of the application. The plurality of service categories and the one or more service features associated with the application are rendered to the plurality of users upon successful registration of the plurality of users to the application. Further, the method includes receiving a selection input provided by the plurality of users in the application to access one of a service category of the plurality of service categories and a service feature of the one or more service features. The method further includes rendering a service response corresponding to the selected service category and the selected service feature to the plurality of users.

In another embodiment, an application server is disclosed. The application server includes a communication interface, a memory configured to store instructions, and a processor communicably coupled to the communication interface and the memory. The processor is configured to execute the instructions stored in the memory and thereby cause the application server to at least render at least a plurality of service categories and one or more service features associated with an application to a plurality of users of the application. The plurality of service categories and the one or more service features associated with the application are rendered to the plurality of users upon successful registration of the plurality of users to the application. Further, the application server is configured to receive a selection input provided by the plurality of users in the application to access one of a service category of the plurality of service categories and a service feature of the one or more service features. The application server is further configured to render a service response corresponding to the selected service category and the selected service feature to the plurality of users.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2A illustrates an exemplary representation of a user interface (UI) depicting the registration portal for registering to an application, in accordance with an embodiment of the present disclosure;

FIG. 2B illustrates an exemplary representation of a user interface (UI) for registration of a first set of users in the application, in accordance with an embodiment of the present disclosure;

FIG. 2C illustrates an exemplary representation of a user interface (UI) for registration of a second set of users and a third set of users in the application, in accordance with an embodiment of the present disclosure;

FIG. 3A illustrates an exemplary representation of a user interface (UI) depicted to the first set of users upon successful completion of the registration process, in accordance with an embodiment of the present disclosure;

FIG. 3B illustrates an exemplary representation of a user interface (UI) depicting a plurality of sub-options of a fire safety service category, in accordance with an embodiment of the present disclosure;

FIG. 3C illustrates an exemplary representation of a user interface (UI) depicted to the second set of users upon successful completion of the registration process, in accordance with an embodiment of the present disclosure;

FIG. 3D illustrates an exemplary representation of a user interface (UI) depicted to the third set of users upon successful completion of the registration process, in accordance with an embodiment of the present disclosure;

FIG. 3E illustrates an exemplary representation of a user interface (UI) rendered to the first set of users upon successful completion of the registration process, in accordance with an embodiment of the present disclosure;

FIG. 4 illustrates an exemplary representation of a user interface (UI) rendered to the first set of users upon clicking the button to enter an admin setup mode in the application, in accordance with an embodiment of the present disclosure;

FIG. 5 illustrates an exemplary representation of a user interface (UI) rendered to the first set of users in the application for creating a service request, in accordance with an embodiment of the present disclosure;

FIGS. 6A and 6B illustrate an exemplary representation of user interfaces (UIs) for creating emergency contacts, in accordance with an embodiment of the present disclosure;

FIGS. 7A and 7B illustrate an exemplary representation of user interfaces (UIs) for creating emergency plans, in accordance with an embodiment of the present disclosure;

FIG. 8 illustrates an exemplary representation of a user interface (UI) for defining a geo-location area, in accordance with an embodiment of the present disclosure;

FIGS. 9A and 9B illustrate an exemplary representation of user interfaces (UIs) for providing training and assessment related to service categories, in accordance with an embodiment of the present disclosure;

FIG. 10 illustrates an exemplary representation of a user interface (UI) depicting assessment reports, in accordance with an embodiment of the present disclosure;

FIG. 11 illustrates an exemplary representation of a user interface (UI) depicting the service request, in accordance with an embodiment of the present disclosure;

FIG. 12 illustrates an exemplary representation of a user interface (UI) depicting a service response of geo-safety feature, in accordance with an embodiment of the present disclosure;

FIG. 13 illustrates an exemplary representation of a user interface (UI) depicting at least one alert feature of the application, in accordance with an embodiment of the present disclosure;

FIG. 14 illustrates a flow diagram of a computer-implemented method to provide service responses for facility emergencies, in accordance with an embodiment of the present disclosure;

FIG. 15 illustrates a simplified block diagram representation of an application server, in accordance with an embodiment of the present disclosure; and

FIG. 16 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

As used herein, the term ‘facility’ represents a workplace where a plurality of users engages in professional activities and perform their job duties. Various workplaces may include an office, a hospital, a restaurant, a hotel, an educational institution, a construction site, a laboratory, and the like.

As used herein, the term ‘first set of users’ represents an admin or a chief operating officer or an operations manager or a senior manager at a facility. The first set of users provides support and monitor the activities of other users (e.g., second set of users and third set of users) at the facility. Further, the first set of users may guide the plurality of users to navigate their roles and make informed decisions.

As used herein, the term ‘second set of users’ represents a first responder or a responder of the service category, or a manager of the service category. The second set of users are designated managers selected by the first set of users based on their facility policies. The second set of users is chosen to provide support to the other users such as third set of users during emergencies.

As used herein, the term ‘third set of users’ represents a technician, an operator, support staff, junior staff, a technical assistant, a field technician, and the like. The third set of users provides technical support, operational support, and emergency and safety support to address the service request.

As used herein, the term ‘emergency service agent’ represents an enforcement team that provides services during an extreme emergency. The emergency service agent provides swift and organized responses to the plurality of users during extreme emergencies.

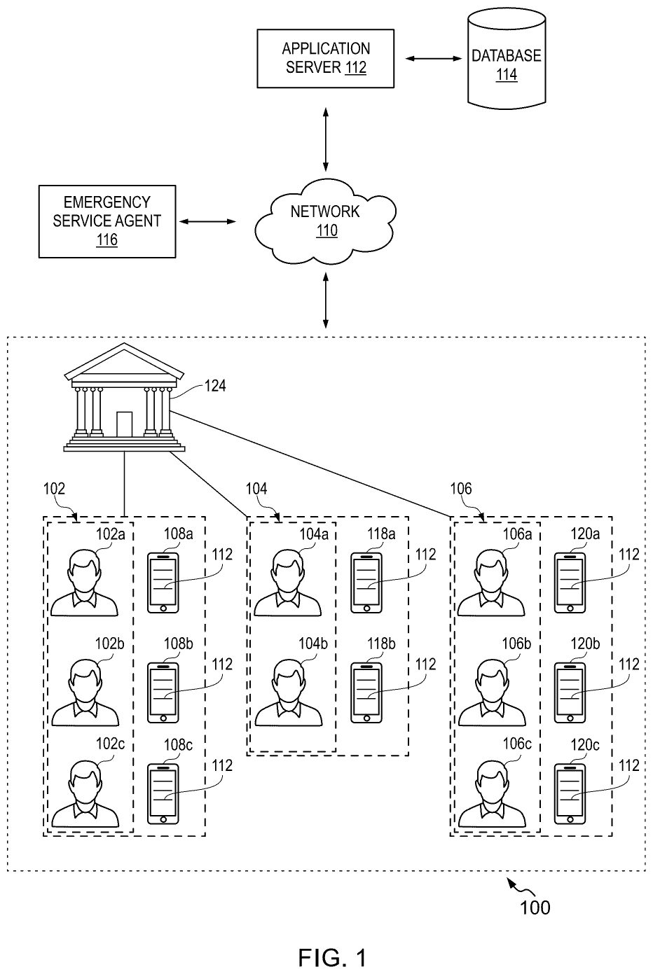

Various embodiments of the present invention are described hereinafter with reference to FIG. 1 to FIG. 16.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 corresponds to a system for providing service responses for facility emergencies. In one example, the system disclosed in the environment 100 may be configured to provide service responses for facility emergencies at a facility 124 during emergencies such as, but not limited to, fire outbreak, elevator entrapment, gas leakage, water leakage, and the like. Alternatively, the system as disclosed in the environment 100 may be implemented to provide service responses at the facility 124 during other emergencies such as severe weather conditions, electrical power loss, and the like.

The environment 100 includes a plurality of users including a first set of users 102, a second set of users 104, and a third set of users 106. The first set of users 102 includes a user 102a, a user 102b, and a user 102c. The users 102a, 102b, and 102c are associated with a user device 108a, a user device 108b, and a user device 108c, respectively. The second set of users 104 includes a user 104a and a user 104b. The user 104a may be associated with a user device 118a and the user 104b may be associated with a user device 118b. Further, the third set of users 106 includes a user 106a, a user 106b, and a user 106c. The user 106a may be associated with a user device 120a, the user 106b may be associated with a user device 120b, and the user 106c may be associated with a user device 120c.

The user devices 108a-108c, the user devices 118a-118b, and the user devices 120a-120c may include at least a laptop computer, a phablet computer, a handheld personal computer, a Virtual Reality (VR) device, a netbook, a Web book, a tablet computing device, a smartphone, or other mobile computing devices. Alternatively, the first set of users 102, the second set of users 104 and the third set of users 106 may be provided with any other user devices which serve the purpose. The environment 100 further includes an application server 112 and a database 114 associated with the application server 112. In one embodiment, the application server 112 may be a separate entity in the environment 100 and communicably coupled to the entities of the environment 100 via a network 110. In an embodiment, the application server 112 may be implemented as a cloud server. In another embodiment, the application server 112 may be embodied in any entity of the environment 100. Further, the database 114 may be configured to store information related to the plurality of users, service responses, emergency plans, information related to contacts of the plurality of users, and assessment reports. The environment 100 further includes an emergency service agent 116.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 110 may include a secure protocol (e.g., Hypertext Transfer Protocol (HTTP)), and/or any other protocol, or set of protocols. In an example embodiment, the network 110 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

In one embodiment, the application server 112 is configured to perform one or more of the operations described herein. Specifically, the application server 112 is configured to host and manage an application 122 for providing service responses for facility emergencies. In an embodiment, the application 122 renders services related to service responses during emergencies. The application 122 may include a plurality of service categories to provide service responses which will be explained further in detail. In an embodiment, the user device 108 is equipped with an instance of the application 122. The application 122 is a set of computer-executable codes configured to provide a user interface (UI) to the plurality of users for providing the service responses. In an embodiment, the application server 112 may render the instance of the application 122, in response to the receipt of a request from the user device 108 via the network 110. In some embodiments, the application 122 may be accessed through the website over the network 110 using web browser applications installed in the user device 108.

In an embodiment, the application server 112 is configured to render at least the plurality of service categories and one or more service features associated with the application 122 to the plurality of users of the application 122. As explained above, the plurality of users may include the first set of users 102, the second set of users 104, and the third set of users 106. Further, the plurality of service categories and the one or more service features associated with the application 122 may be rendered to the plurality of users upon successful registration of the plurality of users to the application 122. Some non-limiting examples of the service categories may include at least fire safety, water safety, electrical power loss, gas leak, active shooter, bomb threat, elevator entrapment, and weather safety. Further, some non-limiting examples of one or more service features may include at least emergency plans, emergency contacts, a geo-safety feature, training records, a user dashboard (or an admin user dashboard), support features, and at least one emergency alert feature.

In one embodiment, the application server 112 may receive registration credentials associated with the first set of users 102 for registering to the application 122. The registration credentials may include at least facility information, contact details, authentication code, and user information. Upon successful validation of the registration credentials, the application server 112 may facilitate the registration of the first set of users 102 in the application 122.

In another embodiment, the application server 112 may receive registration credentials associated with at least the second set of users 104 and the third set of users 106 of the plurality of users for registering to the application 122. The registration credentials may include at least contact details, an authentication code, the facility code, and user information. Further, the application server 112 may facilitate registration of the second set of users 104 and the third set of users 106 of the plurality of users in the application 122. The registration of the second set of users 104 and the third set of users 106 may be based at least on the successful validation of the registration credentials, and receipt of an authorization response from the first set of users 102 of the plurality of users.

The application server 112 may render a virtual assistant in the application 122 upon registration of the plurality of users in the application 122. The virtual assistant may be a two-dimensional(2D)/three-dimensional (3D) character. Further, the application server 112 may receive a selection input provided by the plurality of users in the application 122 to access one of a service category of the plurality of service categories and a service feature of the one or more service features. Upon receiving the selection input provided by the plurality of users, the application server 112 may render a service response corresponding to the selected service category and the selected service feature to the plurality of users.

In one embodiment, the application server 112 may receive a service request for the plurality of service categories defined in the application 122 by the first set of users 102 of the plurality of users. The first set of users 102 may create the service request upon selecting a setup mode in the application 122. The service request may include at least media data related to service, location data of a service area, and service details. In an embodiment, the application server 112 may render the service request for the plurality of service categories in the application 122 for providing access to the plurality of users. Further, the application server 112 may receive an input related to the selection of the service request of a service category of the plurality of service categories. Upon receiving the input related to the selection of the service request, the application server 112 may render a service response including a set of actions corresponding to the service request based on the selection of the service request from the corresponding service category. The set of actions may include at least a media response including a resolution for the service request and a route map for the service request.

As explained above, the service categories may include at least fire safety, water safety, electrical power loss, gas leak, active shooter, bomb threat, elevator entrapment, and weather safety. For example, the first set of users 102 of the plurality of users may select the service request of fire safety of the plurality of service categories upon selecting the setup mode in the application 122. The first set of users 102 may select an option to add media data to the application 122. Upon selecting the option to add media data (e.g., image data), the application 122 may further render two options i.e., take a picture and save. The first set of users 102 may select the option to take a picture for capturing an image related to an equipment of the service category. Upon selecting the option to take a picture, the application 122 may redirect the first set of users 102 to access the device (e.g., the user device 108a) camera for capturing the image. Before capturing the image, the application 122 may request the device camera to provide access for capturing the image. The application 122 may provide one or more options to the first set of users 102. The options may include i.e., (i) don't allow and (ii) allow. Upon selecting the option don't allow by the first set of users 102, a message pops up indicating you have chosen to limit the application 122 functionality. Upon selecting the option by the first set of users 102, the device camera provides access for capturing the image.

Upon capturing the image, the application 122 may further provide one or more options to the first set of users 102. A first option may include a save icon for saving the image. The first set of users 102 may save the image by selecting the save icon. Further, a second option may be used for providing text information related to the image. The first set of users 102 may select the save icon upon providing the text information. Further, the first set of users 102 may enter the option equipment type (i.e., service details). Some non-limiting examples of the equipment type may include a fire pump, fire panel, fire extinguisher, fire assembly area, fire sprinkler shut off, hear AED (automated external debrifillator)-defibrillator, first aid kit, and the like. In an embodiment, the application 122 may detect the geographical location of the service area upon saving the information related to the image in the application 122. Further, the images captured by the application may determine Global Positioning System (GPS) mapping location of at least one of the equipment and the service area. The images further may be propagated to the user devices 108a-108c, the user devices 118a-118b, and the user devices 120a-120c of the plurality of users at the facility. Upon receipt of the above details, the application 122 creates the service request (or stores the images and GPS location of equipment or area. If an emergency occurs, users listen to audio and visual instruction of how to respond to emergencies. Further, the application server 112 may render the service request for other service categories defined in the application 122 and provide a service response corresponding to the service request based on the user's selection of the service request from the corresponding service category.

In another embodiment, the application server 112 may render a service response including an assessment report of at least the second set of users 104 and the third set of users 106 of the plurality of users to the first set of users 102. The service response including the assessment report may be rendered in the application 122 in response to the selection of the setup mode and the training records associated with the one or more service features. The assessment report may include assessment data related to the plurality of service categories. Upon registration, the second set of users 104 and the third set of users 106 of the plurality of users may at least select the service feature to undergo training provided in the application 122.

In an embodiment, the application server 112 may create an emergency contacts list in the application 122 for each of the plurality of service categories. The emergency contacts list may be created based at least on user inputs of the first set of users 102 on emergency contacts associated with the one or more service features. For example, the emergency contacts list may include user details including name, and contact details including mobile numbers and email.

Further, the application server 112 may create emergency plans for each of the plurality of service categories. The emergency plans may be created based at least on a selection input on emergency plans associated with the one or more service features. The emergency plans may include at least emergency plan documentation and the emergency contacts associated with each of the plurality of service categories. The emergency contacts list and the emergency plans may be created for each of the plurality of service categories by the first set of users 102 based at least on the selection of the setup mode in the application 122. Further, master emergency plans may include emergency plans and the resolution of one or more service categories. The emergency contact list of the one or more service categories may be merged into the master emergency plans by the first set of features 102. More specifically, the first set of users 102 of the plurality of users may upload and download the emergency plan. Further, the second set of users 104 and the third set of users 106 of the plurality of users may download the emergency plan. For example, the emergency plan may include a fire safety emergency plan, elevator emergency plan, and the like.

In an embodiment, the application server 112 may render a service response including geo-location data in response to the selection of a geo-safety feature associated with the one or more service features of the application 122. More specifically, the geo-location data may include location data of the service area associated with the service request, information related to the plurality of users present within a geo-location area defined for the service area, and information related to the plurality of users present outside the geo-location area. In addition, the geo-location area may be defined by the first set of users 102 of the plurality of users. The geo-location area may be visible for the first set of users 102 of the plurality of users. The geo-safety feature may dynamically monitor the plurality of users during emergencies at the facility and exhibits the geo-location data of the plurality of users in real time.

Further, the application server 112 may transmit a first alert notification to the plurality of users. The first alert notification may be transmitted in response to user inputs of at least one user of the plurality of users on at least one emergency alert feature associated with the one or more service features. Further, the application server 112 may transmit a second alert notification to the emergency service agent 116 in response to user inputs of the at least one user of the plurality of users. The description related to the one or more operations of the application server 112 and the application 122 for providing the service response to the service categories and the service features are explained further in detail.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

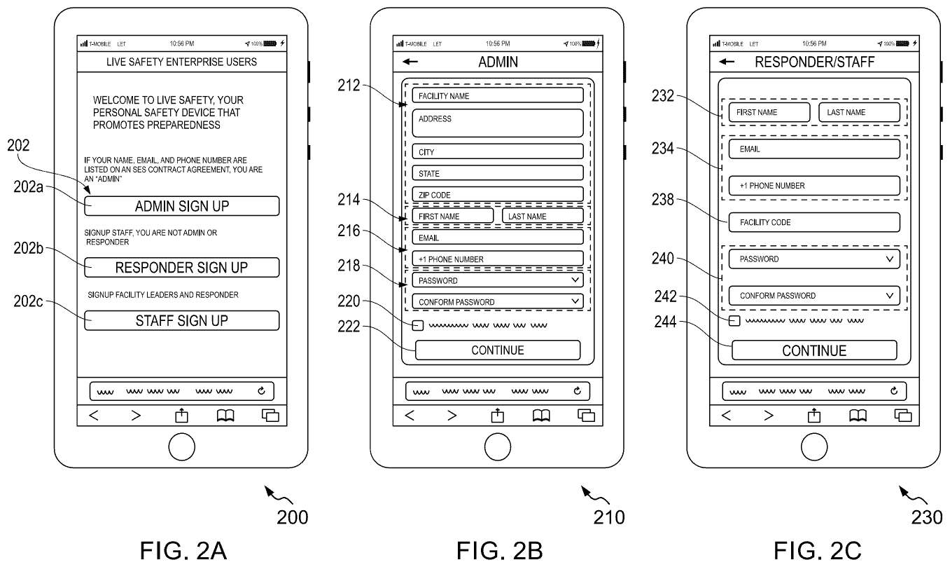

FIG. 2A illustrates an exemplary representation of a user interface (UI) 200 depicting the registration portal for registering to the application 122, in accordance with an embodiment of the present disclosure. The UI 200 corresponds to the registration portal. The UI 200 is depicted to include a plurality of options 202 for allowing the plurality of users (such as the first set of users 102, the second set of users 104, and the third set of users 106) to register to the application 122. The plurality of options 202 includes an option 202a, an option 202b, and an option 202c. The options 202a, 202b, and 202c are exemplarily depicted to include the text “ADMIN SIGN UP”, “RESPONDER SIGN UP”, and “STAFF SIGN UP”. The first set of users 102 may use the option 202a for registering to the application 122. The second set of users 104 may use the option 202b for registering to the application 122. The third set of users 106 may use the option 202c for registering to the application 122. Upon providing the selection input on the options 202a, 202b, and 202c by the corresponding first set of users 102, the second set of users 104, and the third set of users 106, the application 122 may provide corresponding user interfaces (UIs) for registering to the application. The user interfaces (UIs) rendered by the application 122 to the corresponding first set of users 102, the second set of users 104, and the third set of users 106 are explained in detail with references to FIGS. 2B and 2C.

FIG. 2B illustrates an exemplary representation of a user interface (UI) 210 for registration of the first set of users 102, in accordance with an embodiment of the present disclosure. The UI 210 is rendered to the first set of users 102 upon providing their selection input on the option 202a. The UI 210 corresponds to a registration form including a plurality of data fields for receiving inputs from the first set of users 102. The UI 210 is depicted to include a facility information section 212 for receiving information about the facility (e.g., the facility 124). The facility information may include at least a facility name and facility address. The first set of users 102 may provide corresponding input related to the facility information in the data fields associated with the facility information section 212. Further, the UI 210 may include a user information section 214 for receiving user information of the first set of users 102. The user information may include a username. The UI 210 is further depicted to include a contact details section 216 and an authentication code section 218. The first set of users 102 may provide their contact details (such as an email address and a phone number) in the contact details section 216. Further, the first set of users 102 provides an authentication code (i.e., password) in the data fields associated with the authentication code section 218. Upon providing the registration credentials in the data fields in the UI 210, the first set of users 102 may provide input in a dialog box 220 to provide consent for registering to the application 122. Thereafter, the first set of users 102 may click on a button 222 to complete the one-time registration process in the application 122.

FIG. 2C illustrates an exemplary representation of a user interface (UI) 230 for registration of the second set of users 102, in accordance with an embodiment of the present disclosure. The UI 230 is rendered to the second set of users 104 and the third set of users 106 upon providing their selection input on the corresponding options 202b and 202c. The UI 230 corresponds to a registration form including a plurality of data fields for receiving inputs from the second set of users 104 and the third set of users 106. The UI 230 is depicted to include a contact details section 234, an authentication code section 240, a facility code data field 238, and user information section 232. The second set of users 104 and the third set of users 106 may provide contact details in the contract details section 232. The contact details may include at least an email address and phone number. The second set of users 104 and the third set of users 106 may provide user information (such as the user name) in the user information section 232. Further, the second set of users 104 and the third set of users 106 may enter the authentication code and the facility code in the authentication code section 240 and the facility code data field 238. The facility code may be provided to the second set of users 104 and the third set of users 106 by the first set of users 102. The facility code may be used to authenticate the users as the second set of users 104 and the third set of users 106 for registering them in the application 122. Thereafter, the second set of users 104 and the third set of users 106 may provide input in a dialog box 242 to provide consent for registering to the application 122. Thereafter, the second set of users 104 and the third set of users 106 may click on a button 244 to complete the one-time registration process in the application 122. The second set of users 104 and the third set of users 106 are registered in the application 122 upon authorization by the first set of users 102. In other words, the first set of users 102 may receive a notification when the second set of users 104 and the third set of users 106 provide the input on the button 244 for registering in the application 122. The first set of users 102 may provide the authorization response to the application server 112. Upon receipt of the authorization response, the application server 112 enables the registration of the second set of users 104 and the third set of users 106 in the application 122.

It is to be noted that the registration of the first set of users 102, the second set of users 104, and the third set of users 106 are not limited to the illustration as shown in FIGS. 2A, 2B, and 2C. Further, the registration of the users (i.e., the first set of users 102, the second set of users 104, and the third set of users 106) can be implemented by uploading Comma-Separated Values (CSV) files of user's authentication data into the core database (i.e., the database 114).

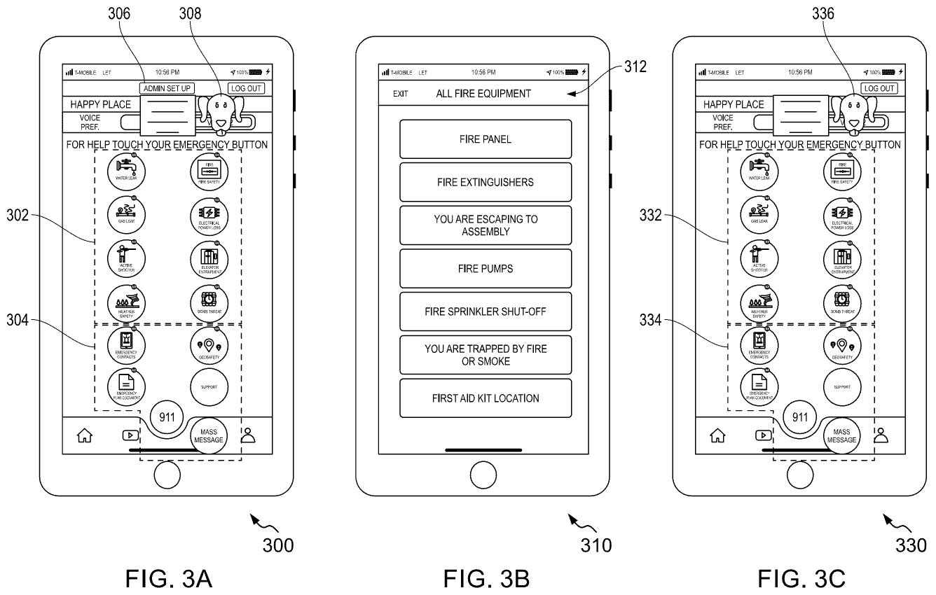

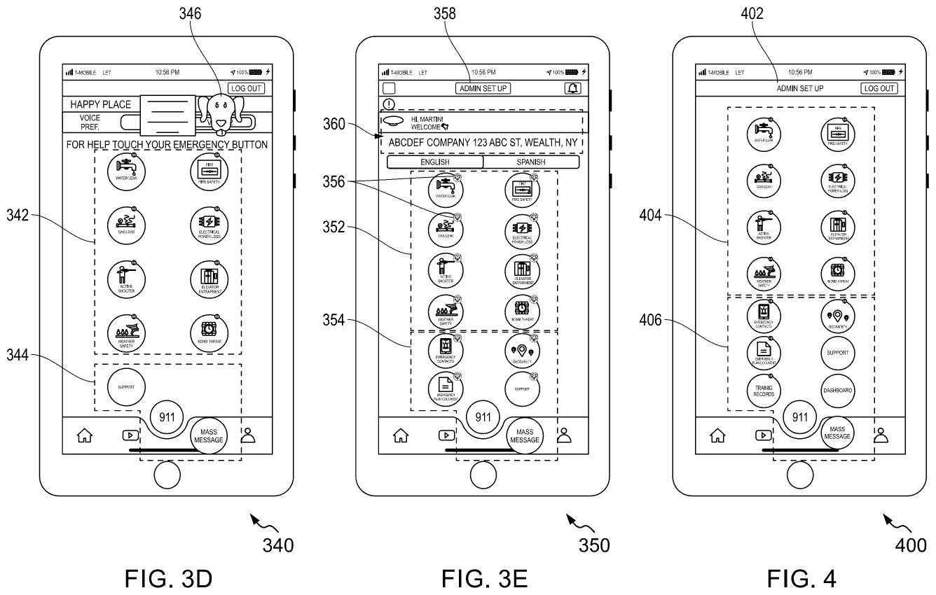

FIG. 3A illustrates an exemplary representation of a user interface (UI) 300 depicted to the first set of users 102 upon successful completion of the registration process, in accordance with an embodiment of the present disclosure. The UI 300 is depicted to include a plurality of service categories 302 and one or more service features 304. The service categories 302 may include at least fire safety, water leak, electrical power loss, gas leak, active shooter, bomb threat, elevator entrapment, and weather safety. Further, the one or more service features 304 may include at least emergency plans, emergency contacts, a geo-safety feature, training records, a user dashboard, notifications, support features, and at least one emergency alert feature.

In an embodiment, the service categories such as fire safety, water leak, electrical power loss, weather safety, and active shooter may include a plurality of sub-options. In one example scenario, the user (e.g., the user 102a) may click on the fire safety service category to access a plurality of sub-options 312 of the fire safety service category. Upon clicking the fire safety service category, the application 122 may render a user interface (UI) (see, 310 of FIG. 3B) depicting the sub-options 312 of the fire safety service category. For example, the sub-options 312 of the fire safety service category may include, but not limited to, fire panel, fire extinguishers, escaping to assembly, fire pumps, fire sprinkler shut-off, first aid kit location, and trapped by fire or smoke. The electrical power loss service category may include sub-options such as, but not limited to, an electrical generator and electric ON-OFF switch (not shown in FIGS.). The weather safety service category may include sub-options such as, but not limited to, Hurricane and Flooding, Tornados, Forest fires, and Winter storms. The water leak service category may include sup-options such as, but not limited to, main facility/complex shut-off, floor shut-off, room shut-off, and critical equipment shut-off.

The UI 300 is further depicted to include a button 306 (associated with the text ‘ADMIN SETUP’). The user 102a may provide input on the button 306 for accessing additional services associated with the service categories 302 and the service features 304. It is to be noted that the button 306 is provided in the application 122 to only the first set of users 102. As explained above, the first set of users 102 may be referred to as the facility's 124 admins (or first-level technicians). Further, the first set of users 102 may be rendered with a virtual assistant (see, 308 of FIG. 3A) upon successful registration of the first set of users 102 in the application 122. The virtual assistant 308 may guide the first set of users 102 through each of the options (such as the service categories 302 and the service features 304) of the application 122. The first set of users 102 may exit the automated guide of the virtual assistant 308 at any time.

Similarly, the second set of users 104 and the third set of users 106 are rendered with a user interface (see, 330 of FIG. 3C) and a user interface (see, 340 of FIG. 3D). The UI 330 is depicted to include a plurality of service categories 332 and one or more service features 334. It is to be noted that all the service categories (i.e. the service categories 302) and the service features (i.e. the service features 304) as listed in the UI 300 are listed in the service categories 332 and the service features 334 of UI 330. Further, the second set of users 104 may be rendered with a virtual assistant (see, 336 of FIG. 3C) upon successful registration of the second set of users 104 in the application 122. The virtual assistant 336 is similar to the virtual assistant 308, therefore the description related to the virtual assistant 336 is not explained herein for the sake of brevity. Further, the UI 340 is depicted to include a plurality of service categories 342 and one or more service features 344. In this scenario, the service categories 342 may include fire safety, water leak, electrical power loss, gas leak, active shooter, bomb threat, elevator entrapment, and weather safety. Further, the service features 344 may include at least one emergency alert feature and support feature. Furthermore, the third set of users 106 may be rendered with a virtual assistant (see, 346 of FIG. 3D) upon successful registration of the third set of users 106 in the application 122. The virtual assistant 346 is similar to the virtual assistants 308 and 336, therefore the description related to the virtual assistant 346 is not explained herein for the sake of brevity.

Referring to FIG. 3E, the first set of users 102 is rendered with a user interface (UI) 350 upon successful registration to the application 106, in accordance with an embodiment of the present disclosure. The UI 350 is depicted to include a plurality of service categories 352 and one or more service features 354. It is to be noted that all the service categories (i.e. the service categories 302) and the service features (i.e. the service features 304) as listed in the UI 300 are similar to the service categories 352 and the service features 354 of the UI 350. For example, the service categories 352 may include fire safety, water leak, electrical power loss, gas leak, active shooter, bomb threat, elevator entrapment, and weather safety. Further, the one or more service features 354 may include at least emergency plans, emergency contacts, a geo-safety feature, training records, support features, an admin user dashboard, and at least one emergency alert feature. The UI 350 is further depicted to include an information field 360. The information field 360 is configured to depict details related to the user (e.g., the user 102a). The details related to the user 102a may include a username and geographical location of the work area of the user 102a within the facility124.

The UI 350 is further depicted to include a button 358 (associated with the text ‘ADMIN SETUP’). It is to be noted that the button 358 is provided in the application 122 to only the first set of users 102. The button 358 is similar to the button 306, therefore the description related to the button 358 is not explained herein for the sake of brevity. Further, the UI 350 is rendered with a virtual assistant (see, 356)upon successful registration of the first set of users 102 in the application 122. As shown, the virtual assistant 356 is rendered on each of the plurality of service categories 352 and each of the one or more service features 354. Upon providing input on the virtual assistant 356, the virtual assistant 356 may guide through each of the corresponding service categories 352 or the service features 354 to which the virtual assistant 356 is associated with. For example, the user 102a may provide input on the virtual assistant 356 associated with fire safety service category. In this scenario, the virtual assistant 356 may provide a guide to the user 102a through the fire safety service category. The guide may include, but not limited to, resolution for the fire safety service category, first aid for the fire safety service category, and the like. Further, the virtual assistant 356 is similar to the virtual assistant 308, therefore the description related to the virtual assistant 356 is not explained herein for the sake of brevity.

Referring to FIG. 4, the user (e.g., the user 102a) may provide the input on the button 306 to enter an admin setup mode in the application 122. Upon clicking the button 306, the user 102a may be provided with a user interface (UI) 400 in the application 122. The UI 400 includes a title 402 associated with the text ‘ADMIN SETUP’. Further, the UI 400 depicts a plurality of service categories 404 and one or more service features 406. The service categories 404 and the service features 406 are examples of the service categories 302 and the service features 304. The user 102a may provide input on the water leak service category of the plurality of service categories 404 to create a service request for the water leak service category. The service categories 404 may include at least fire safety, water leak, electrical power loss, gas leak, active shooter, bomb threat, elevator entrapment, and weather safety. Further, the one or more service features 406 may include at least emergency plans, emergency contacts, a geo-safety feature, training records, an admin user dashboard, support features, and at least one emergency alert feature. Further, the user 102a may provide input on an admin user dashboard feature of the one or more service features to view activity of the users (e.g., the third set of users 106 and/or the second set of users 104) . Furthermore, the user 102a may click on the support features to open a website support page. The web support page may include Frequently Asked Questions (FAQs) related to the application 122.

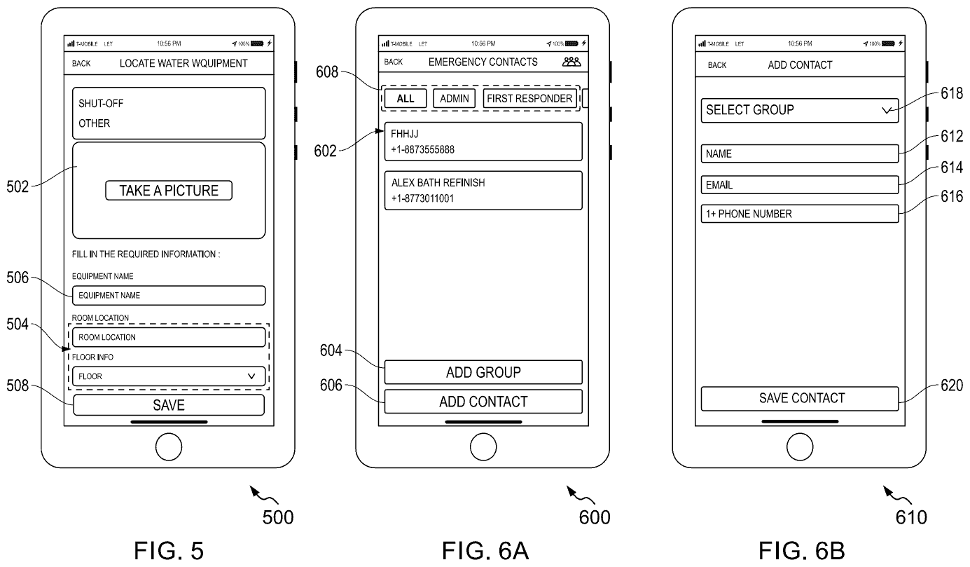

FIG. 5 illustrates an exemplary representation of a user interface (UI) 500 rendered to the first set of users 102 in the application 122 for creating a service request, in accordance with an embodiment of the present disclosure. The user (such as the user 102a) is provided with the user interface (UI) 500 upon selecting the water leak service category of the plurality of service categories 404. The UI 500 corresponds to the service request. The UI 500 is depicted to include a data field 502 for receiving the media data related to the service (i.e., the water leak service) . The media data is exemplarily depicted as image data. In an embodiment, the image data may be captured by an imaging module of the user device 108a of the user 102a. In another embodiment, the image data may be uploaded from a local storage associated with the user device 108a. Alternatively, the media data may include video data or any other form of data related to the service. Further, the UI 500 depicts a location section 504 for receiving the location data of the service area in the facility 124. The user 102a may provide the service details of the water leak service in a data field 506 rendered in the UI 500. For example, the user 102a may provide the equipment name of the water leak as the service details in the UI 500. In addition, the application 122 may extract location of the user device 108a to log the location data of the service area. Upon providing the inputs in the UI 500, the user 102a may save/create the service request by providing the input on a button 508 of the UI 500. Further, the service request for the water leak service category created by the user 102a is rendered in the application 122. This allows the other users (such as the second set of users 104 and the third set of users 106) of the application 122 to access the service request to resolve the issue which will be explained further in detail. Similarly, the user 102a may create the service request for other service categories of the plurality of service categories 404 as explained above.

FIGS. 6A and 6B illustrate an exemplary representation of user interfaces (UIs) for creating emergency contacts, in accordance with an embodiment of the present disclosure.

Referring to FIG. 6A, the user 102a is rendered with a UI 600 to create an emergency contacts list upon providing an input on an emergency contact service feature of the one or more service features 406 of the UI 400. The user 102a may provide input on option 604 for creating a group for each service category. The groups created by providing input on the option 604 are listed in a group section (see, 608). The groups herein correspond to the type of users of the application, the type of service category, and the like. The user 102a may add the emergency contacts in the group by clicking on an option 606 (associated with the text ‘ADD CONTACT’) in the UI 600. Upon clicking the option 606, the user 102a may be rendered with a user interface (UI) 610 for selecting the emergency contacts. The UI 610 includes a plurality of data fields such as a data field 612, a data field 614, and a data field 616 for receiving user details and contact details of the emergency contact personnel. The data field 612 receives the user details (e.g., name), the data fields 614 and 616 receive the email address and the phone number. The email address and the phone number herein refer to the contact details. In one embodiment, the user 102a may be provided with a user interface (not shown in FIGS.) to select the emergency contacts stored in the user device 108a. Upon selection of the emergency contacts, the data fields 612-616 may be automatically populated with the user details and the contact details for each of the selected emergency contacts. In an embodiment, the user 102a may manually provide input in the data fields 612-616 related to the emergency contacts. Further, the user 102a may provide input on option 618 to select the group for the selected emergency contacts. Thereafter, the user 102a may provide input on a button 620 to save the emergency contacts for the group. For example, the UI 600 is depicted to include an emergency contacts list 602 associated with a group (exemplarily depicted as ‘ALL’). In this scenario, the emergency contacts list 602 may be accessed by all the users such as the first set of users 102, the second set of users 104, and the third set of users 106 by providing input on the service feature on their respective user devices 108a-108c, 118a-118b, and 120a-120c. It is to be noted that the creation of the emergency contacts list 602 for each group based on the user inputs corresponds to the service response provided by the application 122.

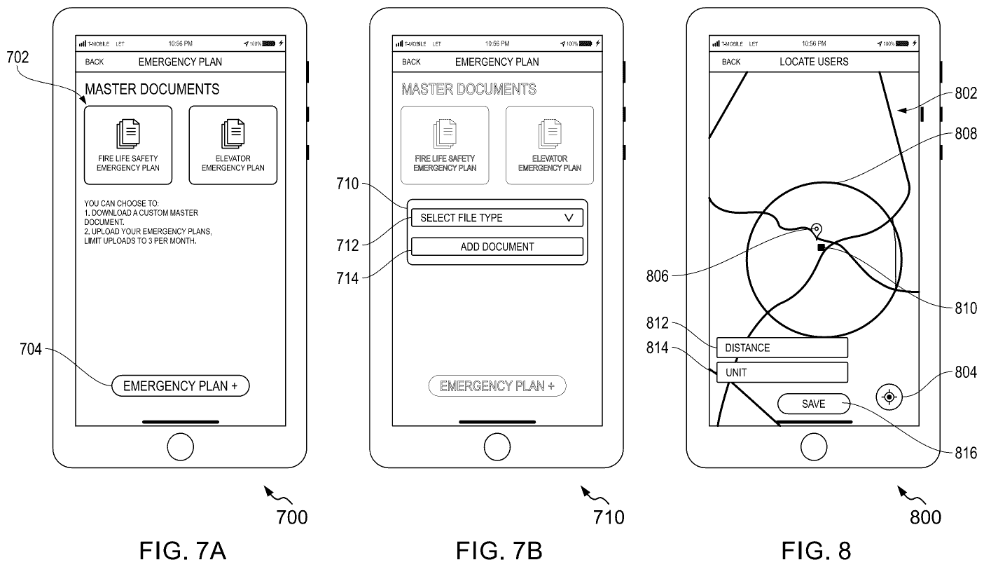

FIGS. 7A and 7B illustrate an exemplary representation of user interfaces (UIs) for creating emergency plans, in accordance with an embodiment of the present disclosure.

Referring to FIG. 7A, the user 102a may be rendered with a user interface (UI) 700 upon selecting the emergency plan option of the one or more service features 406 in the UI 400. The UI 700 is depicted to include emergency plans 702. The emergency plans 702 may include at least emergency plan documentation and the emergency contacts associated with each of the plurality of service categories. As shown, the emergency plans 702 are created for fire safety service category and the elevator service category. In this scenario, the emergency plans 702 created for the fire safety service category and the elevator service category may include the emergency plan documentation and the emergency contacts of the fire safety service category and the elevator service category. The user 102a may select the emergency plans 702 to view and download the emergency plans 702. Further, the UI 700 is depicted to include an option 704 for creating the emergency plan for a specific service category.

Referring to FIG. 7B, the user 102a may be provided with a prompt interface 710 upon selecting the option 704. The prompt interface 710 may be overlaid on the UI 700 (as shown in FIG. 7A). The prompt interface 710 includes an option 712 to select the type of document. Herein, the type of document refers to the service category (for example, water leak). Upon clicking on the option 712, the user 102a may be rendered with a drop-down list including a list of document types (i.e., the list of the service categories) for user selection. Thereafter, the user 102a may provide input on a button 714 to add the document. The user 102a may be rendered with a user interface for selecting the document to be uploaded. For instance, the documents may be selected from the local storage associated with the user device 108a of the user 102a. Once the document is selected, the application 122 creates the emergency plan for the service category (e.g., water leak) by merging the emergency contacts list assigned for the water leak service category. Herein, the emergency plan created for the water leak service category based on the emergency contacts list for the water leak service category and the document uploaded by the user 102a corresponds to the service response.

FIG. 8 illustrates an exemplary representation of a user interface (UI) 800 for defining a geo-location area for a service, in accordance with an embodiment of the present disclosure. The user 102a may be rendered with a user interface (UI) 800 upon selecting the geo-safety feature associated with the one or more service features in the UI 400. The UI 800 is depicted to include a route map 802 and a button 804. The user 102a may provide input on the button 804 to select the location of the facility 124 in the route map 802. Further, the UI 800 may include an actionable icon 806 for allowing the user to adjust a geo-location area 808 from a service area 810. The UI 800 is further depicted to include a data field 812 and a data field 814. The user 102a may provide the inputs related to the distance from the service area (or the center of the facility 124) for defining the geo-location area 808. In an embodiment, the data field 812 may be automatically populated with the distance based on adjusting the geo-location area 808 by providing inputs on the actionable icon 806. Further, the user 102a may provide an input related to a measuring parameter (e.g., meters, kilometers, feet, etc.) for representing the geo-location area 808. Thereafter, the user 102a may save the geo-location area 808 defined for the service area 810 in the application 122 upon clicking a button 816 rendered in the UI 800.

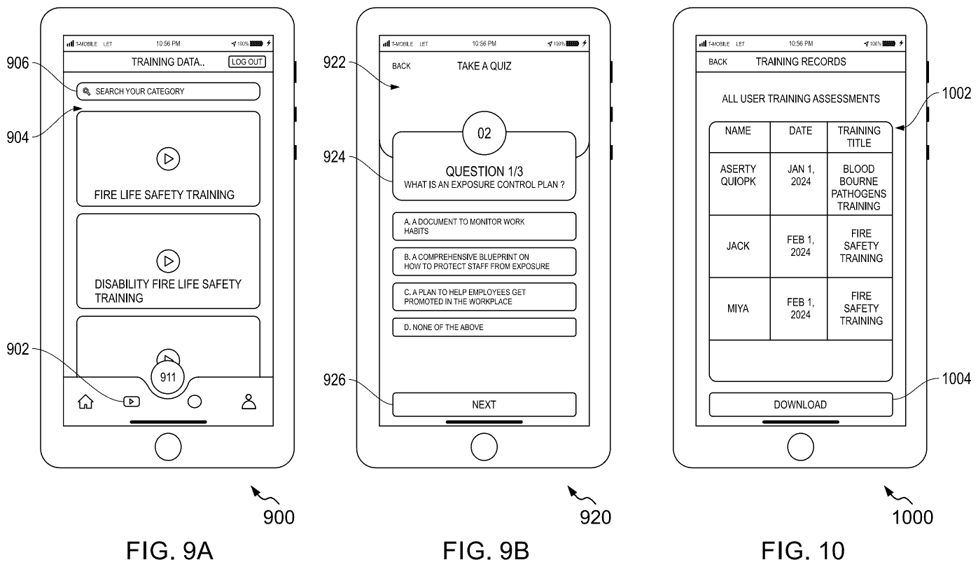

FIGS. 9A and 9B illustrate an exemplary representation of user interfaces (UIs) for providing training and assessment related to service categories, in accordance with an embodiment of the present disclosure.

Referring to FIG. 9A, the users (i.e., the first set of users 102, the second set of users 104, and the third set of users 106) may be provided with a user interface 900 upon clicking on a button 902. The UI 900 is depicted to include a plurality of training data 904 associated with the service categories (e.g., the service categories 302). The application 122 may provide a notification to enable the first set of users 102, the second set of users 104, and the third set of users 106 to access the training data 904 upon successful registration of the first set of users 102, the second set of users 104, and the third set of users 106 in the application 122. Further, the UI 900 is depicted to include a search field 906 for receiving input related to the service category. Upon providing the inputs in the search field 906, the application 122 may render the training data (such as the training data 904) for the service category. The first set of users 102, the second set of users 104, and the third set of users 106 may view the training data 904 to prepare for providing the resolution to the service request.

Referring to FIG. 9B, the users (e.g., the first set of users 102, the second set of users 104, and the third set of users 106) may be provided with a user interface (UI) 920 upon viewing training data from the plurality of training data 904. The UI 920 is depicted to include an assessment 922 related to the viewed training data. For example, the user 104a may view the training data related to ‘FIRE LIFE SAFETY TRAINING’ listed in the plurality of training data 904. Upon viewing the training data related to ‘FIRE LIFE SAFETY TRAINING’, the user 104a is rendered with the UI 920 for taking an assessment related to the ‘FIRE LIFE SAFETY TRAINING’. The assessment 922 may include a set of questions 924 related to ‘FIRE LIFE SAFETY TRAINING’. The user 104a may provide answers to the set of questions 924 to complete the assessment 922. In particular, the user 104a select at least one answer among the listed answers for the listed question in the UI 920. The user 104a may proceed to the next question of the set of questions 924 by providing input on a button 926.

FIG. 10 illustrates an exemplary representation of a user interface (UI) 1000 depicting assessment reports, in accordance with an embodiment of the present disclosure. The UI 1000 is rendered to the first set of users 102 upon clicking on training records associated with the one or more service features 406 of the UI 400. The UI 1000 is depicted to include assessment reports 1002. The assessment reports 1002 may be generated based on the assessment results of the assessment 922 taken by the second set of users 104 and the third set of users 106. In other words, each of the assessment reports 1002 may include assessment data of the assessment 922 related to the plurality of service categories taken by the second set of users 104 and the third set of users 106. The first set of users 102 may download the assessment reports 1002 by clicking on a button 1004 of the UI 1000. It is to be noted that rendering the assessment reports 1002 upon clicking on the training records corresponds to the service response.

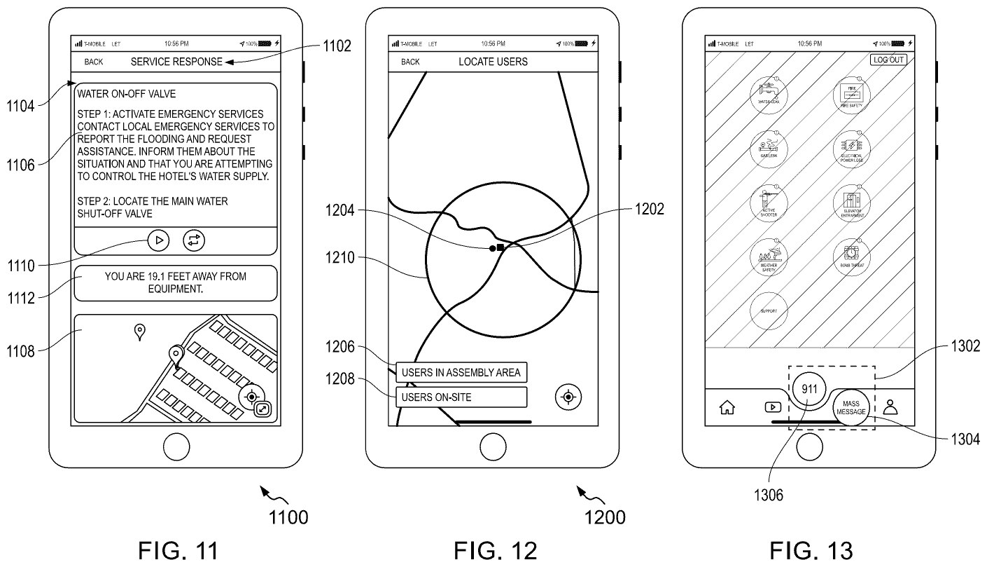

FIG. 11 illustrates an exemplary representation of a user interface (UI) 1100 depicting the service request, in accordance with an embodiment of the present disclosure. The UI 1100 is depicted to the users (e.g., the first set of users 102, the second set of users 104, and the third set of users 106) in the application 122 upon selection of a service category of the plurality of service categories. For instance, the UI 1100 is depicted to include the service request associated with the water leak service category. The UI 1100 is depicted to include a service response section 1102. The service response section 1102 may include a service response 1104. The service response 1104 may include a set of actions corresponding to the service request. The set of actions may include at least a media response including a resolution 1106 for the service request and a route map 1108 for the service request. The user (e.g., the user 106a) may provide input on a button 1110 for viewing the resolution 1106. The router map 1108 indicates the user 106a the distance between the service area and the user 106a and guides the user 106a to reach the service area. The UI 1100 is further depicted to include an information field 1112 for indicating the distance between the service area and the user 106a. For example, the distance between the service area and the user 106a is depicted as “You are 19.1 feet away from equipment”.

FIG. 12 illustrates an exemplary representation of a user interface (UI) 1200 depicting a service response of the geo-safety feature, in accordance with an embodiment of the present disclosure. The UI 1200 is rendered to the user (e.g., the user 102a) in the application 122 upon clicking on geo-safety feature associated with the one or more service features 406 of the UI 400. The UI 1200 corresponds to geo-location data associated with a service area 1202. The UI 1200 (or the geo-location data) includes location data of the service area 1202 associated with the service request. The location data of the service area 1202 may include coordinates of the service area 1202 in the facility 124. The users (e.g., the users 106a and 106b) may be present in the vicinity of the service area 1202 to address the service request. In this scenario, the UI 1200 is depicted to include a location (see, 1204) of the users (e.g., the users 106a and 106b) present in the vicinity of the service area 1202. The users present in the vicinity of the service area 1202 are exemplarily represented using a circle icon in the UI 1200. Further, the UI 1200 is depicted to include a button 1206 and a button 1208. The user (e.g., the user 102a) may click on the button 1206 to access the information related to the plurality of users (e.g., the users 106a and 106b) present within a geo-location area 1210 defined for the service area 1202. Further, the user 102a may click on the button 1208 to access the information related to the plurality of users (e.g., the user 106c) present outside the geo-location area 1210. The geo-location area 1210 is defined by the first set of users 102 as explained with reference to FIG. 8.

FIG. 13 illustrates an exemplary representation of a user interface (UI)depicting at least one alert feature of the application 122, in accordance with an embodiment of the present disclosure. The UI is depicted to include at least one emergency alert feature 1302. The at least one emergency alert feature 1302 associated with the one or more service features is rendered in the application 122 to all the users (i.e., the first set of users 102, the second set of users 104, and the third set of users 106) of the application 122. Further, the service categories and other service features of the application 122 are masked in this UI as the service categories and the service features are rendered differently to the first set of users 102, the second set of users 104, and the third set of users 106.

The at least one emergency alert feature 1302 includes a first emergency alert feature 1304 and a second emergency alert feature 1306. Further, at least one user (e.g., the user 106a) may provide user inputs on the first emergency alert feature 1304 to send a first alert notification to the plurality of users (e.g., the first set of users 102, the second set of users 104, and the third set of users 106b-106c). In other words, the first emergency alert feature 1304 may enable the user 106a to send mass notifications to the users during emergencies. The first alert notification may include a text message from the user 102a or a predefined message rendered by the application 122. Further, the at least one user (e.g., the use 106a)may provide user inputs on the second emergency alert feature 1306 to send a second alert notification to the emergency service agent 116. It is to be noted that the first alert notification and the second alert notification correspond to the service response rendered by the application 122 in response to the user inputs of the at least one user.

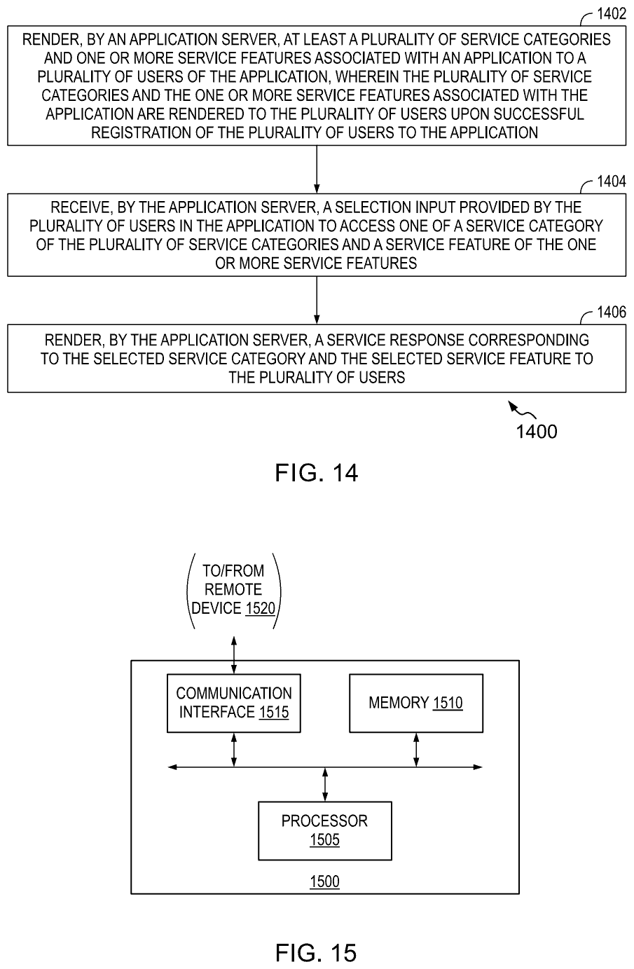

FIG. 14 illustrates a flow diagram of a computer-implemented method 1400 to provide service responses for facility emergencies, in accordance with an embodiment of the present disclosure. The method 1400 depicted in the flow diagram may be executed by, for example, the application server 112. Operations of the flow diagram of the method 1400, and combinations of the operations in the flow diagram of the method 1400, may be implemented by, for example, hardware, firmware, a processor, circuitry, and/or a different device associated with the execution of software that includes one or more computer program instructions. It is noted that the operations of the method 1400 can be described and/or practiced by using a system other than the application server 112. The method 1400 starts at operation 1402.

At operation 1402, the method 1400 includes rendering, by the application server 112, at least a plurality of service categories and one or more service features associated with an application 122 to a plurality of users of the application 122, wherein the plurality of service categories and the one or more service features associated with the application 122 are rendered to the plurality of users upon successful registration of the plurality of users to the application 122.

At operation 1404, the method 1400 includes receiving, by the application server 112, a selection input provided by the plurality of users in the application 122 to access one of a service category of the plurality of service categories and a service feature of the one or more service features.

At operation 1406, the method 1400 includes rendering, by the application server 112, a service response corresponding to the selected service category and the selected service feature to the plurality of users. Further, the one or more operations for providing service responses for facility emergencies and service features are already explained with reference to FIGS. 1 to 13, therefore they are not reiterated herein for the sake of brevity.

FIG. 15 illustrates a simplified block diagram representation of an application server 1500, in accordance with an embodiment of the present disclosure. In an embodiment, the application server 1500 is an example of the application server 112. The application server 1500 includes at least one processor 1505 for executing instructions. Instructions may be stored in, for example, but not limited to, a memory 1510. The memory 1510 may be embodied as one or more volatile memory devices, one or more non-volatile memory devices, and/or a combination of one or more volatile memory devices and non-volatile memory devices. For example, the memory 1510 may be embodied as semiconductor memories (such as mask ROM, PROM (programmable ROM), EPROM (erasable PROM), flash memory, RAM (random access memory), etc.), magnetic storage devices (such as hard disk drives, floppy disks, magnetic tapes, etc.), optical magnetic storage devices (e.g., magneto-optical disks), CD-ROM (compact disc read-only memory), CD-R (compact disc recordable), CD-R/W (compact disc rewritable), DVD (Digital Versatile Disc) and BD (BLU-RAY® Disc).

In an embodiment, the processor 1505 may include one or more processing units (e.g., in a multi-core configuration). Examples of the processor 1505 include, but are not limited to, an application-specific integrated circuit (ASIC) processor, a reduced instruction set computing (RISC) processor, a complex instruction set computing (CISC) processor, a field-programmable gate array (FPGA), and the like. The processor 1505 is operatively coupled to a communication interface 1515 and is capable of communicating with a remote device 1520 such as the user devices 108a-108c, the user devices 118a-118b, and the user devices 120a-120c. The communication interface 1515 may include communication circuitry such as, a transceiver circuitry including an antenna and other communication media interfaces to connect to a wired and/or wireless communication network. The communication circuitry may, in at least some example embodiments, enable the transmission of data signals or control signals or receipt of the user inputs. The one or more operations performed by the application server 1500 are already explained with references to FIG. 14, therefore they are not reiterated herein for the sake of brevity.

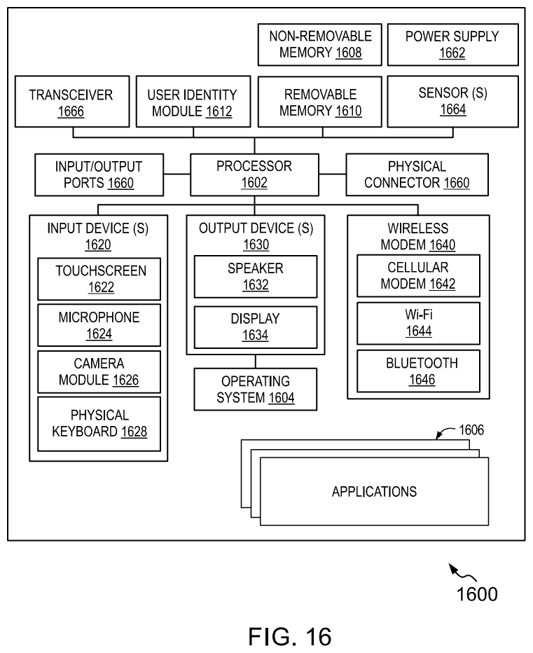

FIG. 16 is a simplified block diagram of an electronic device 1600 capable of implementing various embodiments of the present disclosure. For example, the electronic device 1600 may correspond to at least the user devices 102a-102c, the user devices 104a-104b, and the user devices 106a-106c of FIG. 1. The electronic device 1600 is depicted to include one or more applications 1606. For example, the one or more applications 1606 may include the application 122 of FIG. 1. The one or more applications 1606 installed on the electronic device 1600 is capable of communicating with a server (i.e., the application server 112) to provide service responses for facility emergencies.

It should be understood that the electronic device 1600 as illustrated and hereinafter described is merely illustrative of one type of device and should not be taken to limit the scope of the embodiments. As such, it should be appreciated that at least some of the components described below in connection with the electronic device 1600 may be optional and thus in an embodiment may include more, less, or different components than those described in connection with the embodiment of the FIG. 16. As such, among other examples, the electronic device 1600 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1600 includes a controller or a processor 1602 (e.g., a signal processor, microprocessor, ASIC, or other control and processing logic circuitry) for performing such tasks as signal coding, data processing, image processing, input/output processing, power control, and/or other functions. An operating system 1604 controls the allocation and usage of the components of the electronic device 1600 and supports one or more operations of the application (see, the applications 1606) that implements one or more of the innovative features described herein. In addition, the applications 1606 may include common mobile computing applications (e.g., telephony applications, email applications, calendars, contact managers, web browsers, messaging applications) or any other computing application.

The illustrated electronic device 1600 includes one or more memory components, for example, a non-removable memory 1608 and/or removable memory 1610. The non-removable memory 1608 and/or the removable memory 1610 may be collectively known as a database in an embodiment. The non-removable memory 1608 can include RAM, ROM, flash memory, a hard disk, or other well-known memory storage technologies. The removable memory 1610 can include flash memory, smart cards, or a Subscriber Identity Module (SIM). The one or more memory components can be used for storing data and/or code for running the operating system 1604 and the applications 1606. The electronic device 1600 may further include a user identity module (UIM) 1612. The UIM 1612 may be a memory device having a processor built in. The UIM 1612 may include, for example, a subscriber identity module (SIM), a universal integrated circuit card (UICC), a universal subscriber identity module (USIM), a removable user identity module (R-UIM), or any other smart card. The UIM 1612 typically stores information elements related to a mobile subscriber. The UIM 1612 in the form of the SIM card is well known in Global Systems for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1600 can support one or more input devices 1620 and one or more output devices 1630. Examples of the input devices 1620 may include, but are not limited to, a touch screen/a display screen 1622 (e.g., capable of capturing finger tap inputs, finger gesture inputs, multi-finger tap inputs, multi-finger gesture inputs, or keystroke inputs from a virtual keyboard or keypad), a microphone 1624 (e.g., capable of capturing voice input), a camera module 1626 (e.g., capable of capturing still picture images and/or video images) and a physical keyboard 1628. Examples of the output devices 1630 may include, but are not limited to, a speaker 1632 and a display 1634. Other possible output devices can include piezoelectric or other haptic output devices. Some devices can serve more than one input/output function. For example, the touch screen 1622 and the display 1634 can be combined into a single input/output device.

A wireless modem 1640 can be coupled to one or more antennas (not shown in FIG. 16) and can support two-way communications between the processor 1602 and external devices, as is well understood in the art. The wireless modem 1640 is shown generically and can include, for example, a cellular modem 1642 for communicating at long range with the mobile communication network, a Wi-Fi compatible modem 1644 for communicating at short range with an external Bluetooth-equipped device, or a local wireless data network or router, and/or a Bluetooth-compatible modem 1646. The wireless modem 1640 is typically configured for communication with one or more cellular networks, such as a GSM network for data and voice communications within a single cellular network, between cellular networks, or between the electronic device 1600 and a public switched telephone network (PSTN).

The electronic device 1600 can further include one or more input/output ports 1650, a power supply 1652, one or more sensors 1654 for example, an accelerometer, a gyroscope, a compass, or an infrared proximity sensor for detecting the orientation or motion of the electronic device 1600 and biometric sensors for scanning biometric identity of an authorized user, a transceiver 1656 (for wirelessly transmitting analog or digital signals) and/or a physical connector 1660, which can be a USB port, IEEE 1294 (FireWire) port, and/or RS-232 port. The illustrated components are not required or all-inclusive, as any of the components shown can be deleted and other components can be added.

The disclosed method with reference to FIG. 14, or one or more operations of the application server 112 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the application server 112 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
rendering, by an application server, at least a plurality of service categories and one or more service features associated with an application to a plurality of users of the application, wherein the plurality of service categories and the one or more service features associated with the application are rendered to the plurality of users upon successful registration of the plurality of users to the application;
receiving, by the application server, a selection input provided by the plurality of users in the application to access one of a service category of the plurality of service categories and a service feature of the one or more service features; and
rendering, by the application server, a service response corresponding to the selected service category and the selected service feature to the plurality of users.

2. The computer-implemented method as claimed in claim 1, further comprising:
receiving, by the application server, registration credentials associated with a first set of users of the plurality of users for registering to the application, the registration credentials comprising at least facility information, contact details, authentication code, and user information; and
upon successful validation of the registration credentials, facilitating, by the application server, registration of the first set of users of the plurality of users in the application.

3. The computer-implemented method as claimed in claim 1, further comprising:
receiving, by the application server, registration credentials associated with at least a second set of users and a third set of users of the plurality of users for registering to the application, the registration credentials comprising at least contact details, authentication code, a facility code, and user information; and
facilitating, by the application server, registration of the second set of users and the third set of users of the plurality of users in the application based at least on successful validation of the registration credentials, and receipt of an authorization response from a first set of users of the plurality of users.

4. The computer-implemented method as claimed in claim 1, wherein the plurality of service categories comprises fire safety, water safety, electrical power loss, gas leak, active shooter, bomb threat, elevator entrapment, and weather safety, and
wherein the one or more service features comprise emergency plans, emergency contacts, a geo-safety feature, training records, an admin user dashboard, support features, and at least one emergency alert feature.

5. The computer-implemented method as claimed in claim 1, further comprising:
receiving, by the application server, a service request for the plurality of service categories defined in the application by a first set of users of the plurality of users, wherein the first set of users creates the service request upon selecting a setup mode in the application, the service request comprising at least media data related to service, location data of a service area, and service details.

6. The computer-implemented method as claimed in claim 5, further comprising:
rendering, by the application server, the service request for the plurality of service categories in the application for providing access to the plurality of users;
receiving, by the application server, an input related to the selection of the service request of a service category of the plurality of service categories; and
rendering, by the application server, a service response comprising a set of actions corresponding to the service request based on the selection of the service request from the corresponding service category, the set of actions comprising at least a media response comprising a resolution for the service request and a route map for the service request.

7. The computer-implemented method as claimed in claim 5, further comprising:
rendering, by the application server, a service response comprising an assessment report of at least a second set of users and a third set of users of the plurality of users to the first set of users, wherein the service response comprising the assessment report is rendered in the application in response to the selection of the setup mode and the training records associated with the one or more service features, the assessment report comprising assessment data related to the plurality of service categories.

8. The computer-implemented method as claimed in claim 7, further comprising:
creating, by the application server, an emergency contacts list in the application for based at least on user inputs of the first set of users on emergency contacts associated with the one or more service features, the emergency contacts list comprising user details and contact details; and
creating, by the application server, emergency plans for each of the plurality of service categories based at least on a selection input on emergency plans associated with the one or more service features, wherein the emergency plans comprising at least emergency plan documentation and the emergency contacts associated with each of the plurality of service categories,
wherein the emergency contacts list and the emergency plans are created for each of the plurality of service categories by the first set of users based at least on the selection of the setup mode in the application.

9. The computer-implemented method as claimed in claim 5, further comprising:
rendering, by the application server, a service response comprising geo-location data in response to the selection of a geo-safety feature associated with the one or more service features of the application, the geo-location data comprising location data of the service area associated with the service request, information related to the plurality of users present within a geo-location area defined for the service area, and information related to the plurality of users present outside the geo-location area, wherein the geo-location area is defined by the first set of users of the plurality of users.

10. The computer-implemented method as claimed in claim 1, further comprising:
transmitting, by the application server, a first alert notification to the plurality of users in response to user inputs of at least one user of the plurality of users on at least one emergency alert feature associated with the one or more service features; and
transmitting, by the application server, a second alert notification to an emergency service agent in response to user inputs of the at least one user of the plurality of users on the at least one emergency alert feature associated with the one or more service features,
wherein the first alert notification and the second alert notification correspond to the service response.

11. An application server, comprising:
a communication interface;
a memory storing executable instructions; and
a processor operatively coupled with the communication interface and the memory, the processor configured to execute the executable instructions to cause the application server to at least:
render at least a plurality of service categories and one or more service features associated with an application to a plurality of users of the application, wherein the plurality of service categories and the one or more service features associated with the application are rendered to the plurality of users upon successful registration of the plurality of users to the application,
receive a selection input provided by the plurality of users in the application to access one of a service category of the plurality of service categories and a service feature of the one or more service features, and
render a service response corresponding to the selected service category and the selected service feature to the plurality of users.

12. The application server as claimed in claim 11, wherein the application server is further caused to:
receive registration credentials associated with a first set of users of the plurality of users for registering to the application, the registration credentials comprising at least facility information, contact details, authentication code, and user information; and
upon successful validation of the registration credentials, facilitate registration of the first set of users of the plurality of users in the application.

13. The application server as claimed in claim 11, wherein the application server is further caused to:
receive registration credentials associated with at least a second set of users and a third set of users of the plurality of users for registering to the application, the registration credentials comprising at least contact details, authentication code, a facility code, and user information; and
facilitate registration of the second set of users and the third set of users of the plurality of users in the application based at least on successful validation of the registration credentials, and receipt of an authorization response from a first set of users of the plurality of users.

14. The application server as claimed in claim 11, wherein the plurality of service categories comprises fire safety, water safety, electrical power loss, gas leak, active shooter, bomb threat, elevator entrapment, and weather safety, and
wherein the one or more service features comprise emergency plans, emergency contacts, a geo-safety feature, training records, an admin user dashboard, support features, and at least one emergency alert feature.

15. The application server as claimed in claim 11, wherein the application server is further caused to:
receive a service request for the plurality of service categories defined in the application by a first set of users of the plurality of users, wherein the first set of users creates the service request upon selecting a setup mode in the application, the service request comprising at least media data related to service, location data of a service area, and service details.

16. The application server as claimed in claim 15, wherein the application server is further caused to:
render the service request for the plurality of service categories in the application for providing access to the plurality of users;
receive an input related to the selection of the service request of a service category of the plurality of service categories; and
render a service response comprising a set of actions corresponding to the service request based on the selection of the service request from the corresponding service category, the set of actions comprising at least a media response comprising a resolution for the service request and a route map for the service request.

17. The application server as claimed in claim 15, wherein the application server is further caused to:
render a service response comprising an assessment report of at least a second set of users and a third set of users of the plurality of users to the first set of users, wherein the service response comprising the assessment report is rendered in the application in response to the selection of the setup mode and the training records associated with the one or more service features, the assessment report comprising assessment data related to the plurality of service categories.

18. The application server as claimed in claim 17, wherein the application server is further caused to:
create an emergency contacts list in the application for based at least on user inputs of the first set of users on emergency contacts associated with the one or more service features, the emergency contacts list comprising user details and contact details; and
create emergency plans for each of the plurality of service categories based at least on a selection input on emergency plans associated with the one or more service features, wherein the emergency plans comprising at least emergency plan documentation and the emergency contacts associated with each of the plurality of service categories, and
wherein the emergency contacts list and the emergency plans are created for each of the plurality of service categories by the first set of users based at least on the selection of the setup mode in the application.

19. The application server as claimed in claim 15, wherein the application server is further caused to:
render a service response comprising geo-location data in response to the selection of a geo-safety feature associated with the one or more service features of the application, the geo-location data comprising location data of the service area associated with the service request, information related to the plurality of users present within a geo-location area defined for the service area, and information related to the plurality of users present outside the geo-location area, wherein the geo-location area is defined by the first set of users of the plurality of users.

20. The application server as claimed in claim 11, wherein the application server is further caused to:
transmit a first alert notification to the plurality of users in response to user inputs of at least one user of the plurality of users on at least one emergency alert feature associated with the one or more service features; and
transmit a second alert notification to an emergency service agent in response to user inputs of the at least one user of the plurality of users on the at least one emergency alert feature associated with the one or more service features,
wherein the first alert notification and the second alert notification correspond to the service response.
